(19) United States
(12) Patent Application Publication
(10) Pub. No.: US 2015/0207911 A1
(43) Pub. Date: Jul. 23, 2015

(54) AUDIO ENHANCING AND AMPLIFYING SYSTEM FOR CELL PHONE PROTECTIVE CASE

(71) Applicant: Alan Nathan Lin, Arcadia, CA (US)

(72) Inventor: Alan Nathan Lin, Arcadia, CA (US)

(21) Appl. No.: 14/160,355

(22) Filed: Jan. 21, 2014

(51) Int. Cl. H04M 1/60; H04M 1/04

(52) U.S. Cl. CPC H04M 1/6041; H04M 1/04

(57) ABSTRACT

A protective case discloses an electronic device protective casing, comprising an outer wall of back cover of outer protective layer and an inner wall of the back cover of the outer protective layer. The protective case further comprises an inner flexible layer corresponds to the inner wall of the back cover of the outer protective layer. The back cover comprises an amplifying chamber. Furthermore, the outer layer of the protective case can be made with hard material such as polycarbonate (PC) and the inner flexible layer can be made with soft material such as thermoplastic polyurethane (TPU), so that the protective case is able to protect the electronic device from drops and shocks. Finally, the sound emitted from the speaker of the electronic device comes through the amplifying chamber on the back cover of the protective case with an enhanced, amplified, better quality and wider range sound.

### FIELD OF THE INVENTION

The present invention relates to the accessories for electronic devices such as cell phones and more particularly a protective case for such devices.

### BACKGROUND OF THE INVENTION

New technology has been growing rapidly for the past decades, and electronic device is among the most growing factors of all. Almost everyone owns a cell phone. And the number is increasing rapidly for the years to come. In the present market, there are so many types of cell phones with different functions, sizes, weights, hardware and software to satisfy the needs of different levels of users.

In order to protect their investment, users seek out for different kind of protective cases and accessories in order to protect their electronic devices. In term of protective case, there are many varieties of cases in the market in the present day. Many different cases are made for different looks and purposes.

Most cell phones have loud speaker or speakers to be able to broadcast the sound to their users. There are cellular phones with loud speaker(s) in the rear portion and there are some on the sides. Sometimes, loud speakers are not loud enough to be able to satisfy users. Therefore, there are external speakers wired or wireless in the present market, which connect to cell phone in order to perform a satisfactory job in playing media that users prefer. According to the prior art of the case with audio sound diverted from the rear portion to the front of the cell phone, but the sound is not amplified to get a satisfactory result.

Thus, there is a need for an improved case with a mechanical audio amplifying system on the protective case for cell phone.

### SUMMARY

The following summary is provided to facilitate an understanding of some of the innovative features unique to the embodiments and is not intended to be a full description. A full description of the various aspects of the embodiments can be gained by taking the entire specification, claims, drawings and abstracts as a whole.

The present invention of the utility model is to overcome the flaw of the prior art. According to the aspect of the present invention, the following solutions will be applied:
The case comprises two layers, first inner layer is made with soft material, can be silicone like material or can be thermoplastic polyurethane (TPU), and second outer layer consists of front portion and rear portion, made with hard material, can be hard plastic or polycarbonate (PC) or any other hard material. The back part of the inner layer has an opening, which corresponds to speaker of electronic device.
The rear portion of the outer layer has open channels to amplify the sound emitted from the speaker of the electronic device and to guide from the opening of the outer layer through the open guide channels of the outer layer.
The rear portion of the outer layer has multiple openings to ease the flows of the sound emitted from the speaker of the electronic device. The openings are constructed in a fashion that the amplified sound from the electronic device disperses to multiple directions.
The multiple openings are constructed in a fashion that the sound from the speaker of the electronic device is symmetrically emitted through the multiple openings.
Along the back of the rear outer layer, there are at least two amplifying ridges with built-in grooves which are vertically symmetrical to the center line; they further consist of the multiple openings to improve the amplification of the sound emitted from the speaker of the electronic device.
The front portion and the rear portion of the outer layer are casing in the inner soft layer with connected latches along the side of electronic device.
The front portion of the outer layer is formed with a frame that wraps around a transparent clear lens. The transparent clear lens is made with a thin film material to be able to transfer data inputted by finger or fingers of the users to the electronic device.
The transparent clear lens is connected to the front portion frame of the outer layer along the edge of the lens.

### DRAWINGS

These and other features, aspects, and the advantages of the present invention will become better understood with reference to the accompanying drawings, descriptions and appended claims, where:

FIG. 1 is a perspective view of a protective case according to certain embodiment of the present invention;

FIG. 2 is an exploded perspective view showing different layers part of the protective case according to certain embodiment shown in FIG. 1 of the present invention;

FIG. 3 is an elevational view of the rear outer layer of the protective case according to certain embodiment of the present invention;

FIG. 4 is a perspective view showing the exterior part of the rear portion of the outer layer of the protective case according to certain embodiment of the present invention;

FIG. 5 is a perspective view of a protective case according to certain embodiment of the present invention;

FIG. 6 is an exploded perspective view showing different layers of the protective case according to certain embodiment shown in FIG. 5 of the present invention;

### BRIEF DESCRIPTION OF THE DRAWINGS

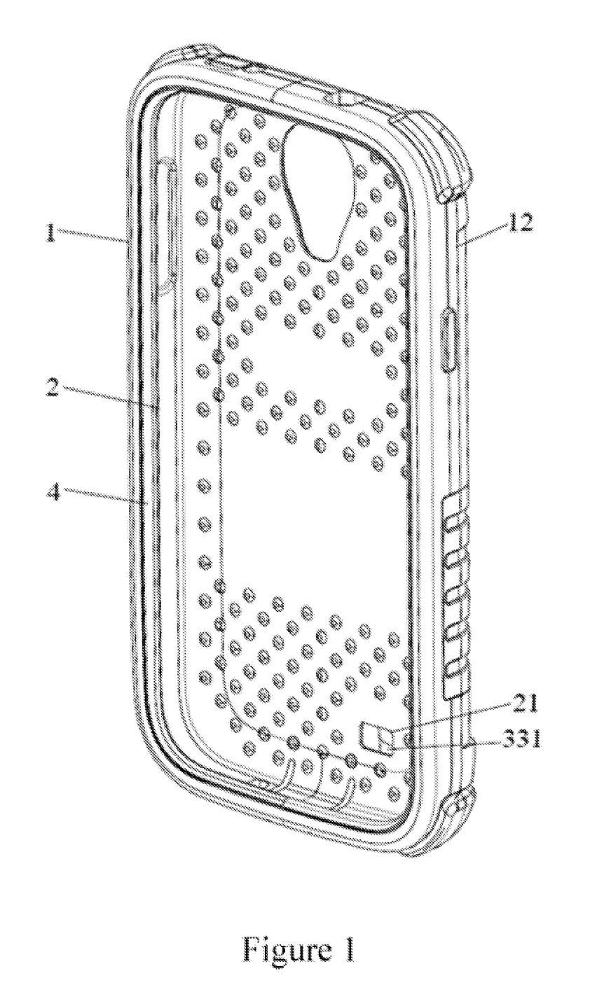

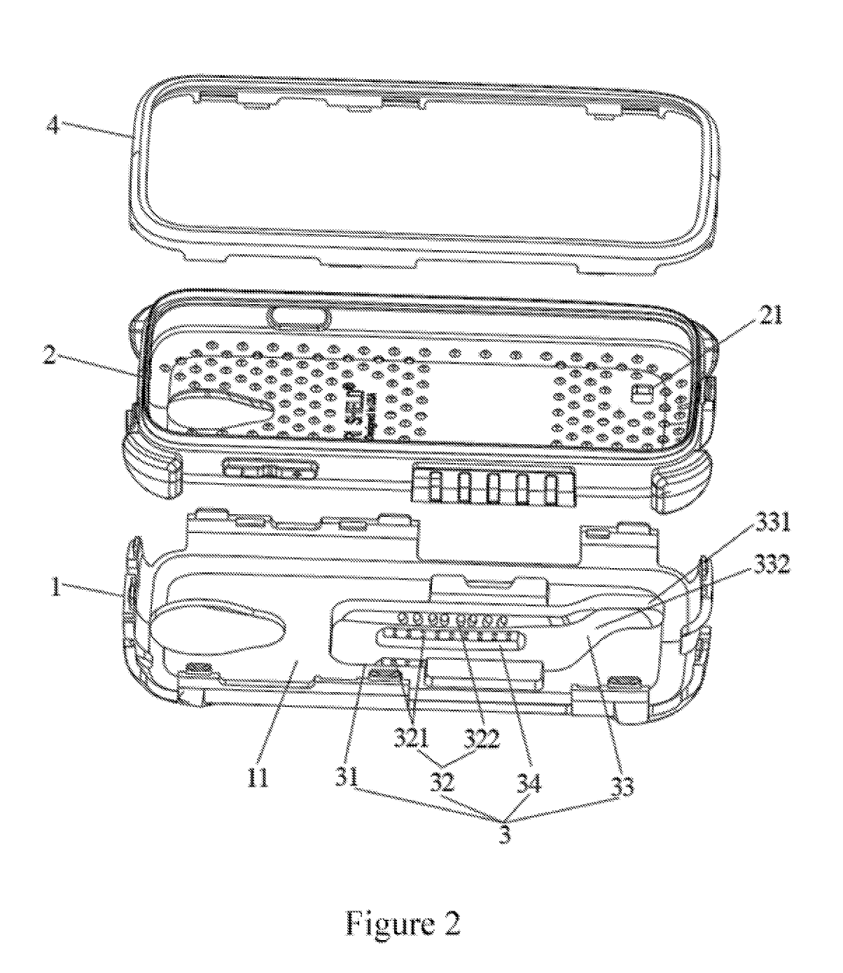

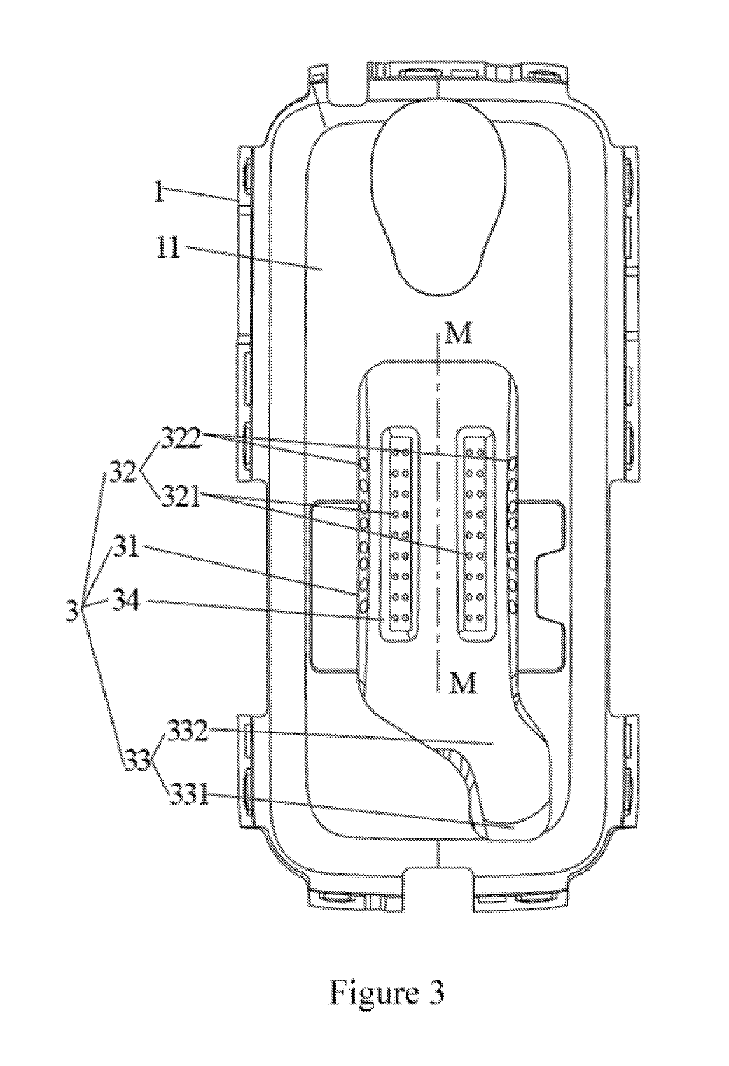

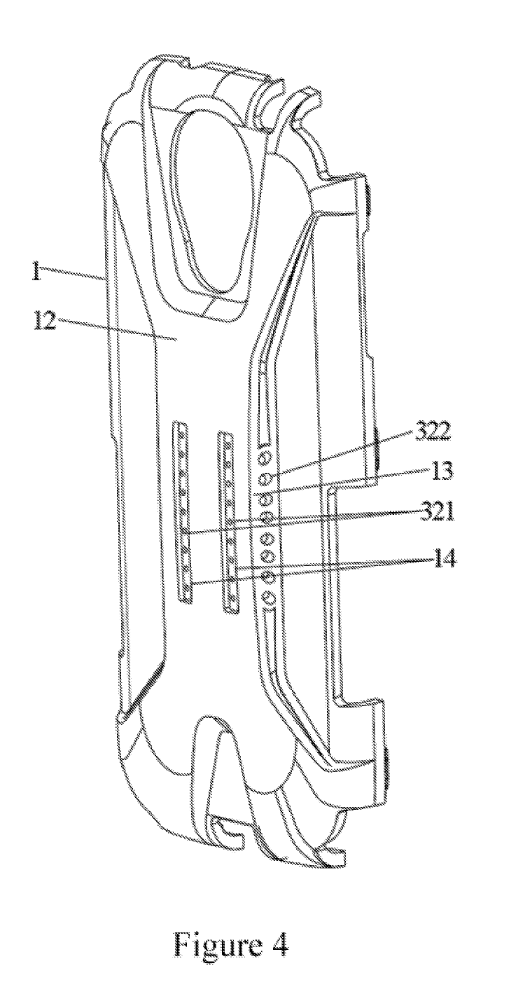

FIG. 1 to FIG. 6:
1. Rear portion of outer layer of protective case;
11. Inner wall of rear portion of outer layer of protective case;
12. Outer wall of rear portion of outer layer of protective case;
13. Protrusion;
14. Recess grooves;
2. Inner flexible layer of protective case;
21. Openings;
3. Audio enhancing and amplifying system;
31. Amplifying chamber;
32. Amplifying openings;
321. Bottom amplifying openings;
322. Side amplifying openings;
33. Audio guide channel;
331. Starting point of audio guide channel;
332. End point of audio guide channel;
34. Ridge;
4. Front portion (frame) of outer layer of protective case;
5. Front portion (Frame) with transparent lens.

### DESCRIPTION OF THE PRESENT INVENTION

With reference to the drawings, the preferred embodiment of the protective case comprising a back cover of hard outer protective layer, an inner flexible layer, and a front frame of the outer layer, according to the present invention is herein described.

As shown in FIG. 1 to FIG. 4, according to certain embodiments of the present invention, the protective case consists of a rear portion of outer protective layer 1 and an inner flexible layer 2. The rear portion of the hard outer protective layer 1 includes an inner wall 11 and an outer wall 12. The inner flexible protective layer 2 is placed on the inner wall 11 of the rear portion of the outer layer 1. The rear portion of the outer layer 1 consists of audio amplifying system 3.

According to certain embodiments of the present invention, it is preferably that the inner flexible layer 2 is made of soft material such as thermoplastic polyurethane (TPU) or soft silicone, and as the rear portion of outer protective layer is made with hard material such as polycarbonate (PC) or any other hard material.

According to certain embodiments of the present invention, the inner flexible protective layer 2 and the outer hard layer 1 of the present are made to protect against shocks and drops. And in the meantime, the outer hard layer 1 of the present invention is constructed with an audio enhancing and amplifying system 3. The sound emitted from the speaker of electronic device through the audio enhancing and amplifying system 3 is resulting with an enhanced sound, louder, better sound quality and also at a wider range.

According to certain embodiments of the present invention, the audio enhancing and amplifying system 3 includes at least an amplifying chamber 31 of the inner wall 11 of the rear portion of the outer hard layer 1. The amplifying chamber 31 consists of multiple amplifying openings 32 and the audio guide channel 33 of the inner wall 11. One end of the audio guide channel 331 corresponds to the speaker of the electronic device. Another end of the audio guide channel 332 connects to the amplifying chamber 31. And the audio emitted from the speaker of the electronic device goes through the opening 21 of the inner flexible protective layer 2 and from the starting point of the audio guide channel 331 through the end point of the audio guide channel 332, in the amplifying chamber 31.

The structure of this preferred embodiment of the present invention is that the audio enhancing and amplifying system 3 enhances and amplifies the audio emitted from the speaker of the electronic device through the audio guide channel 33. And the audio continues through the opening 21 of the inner flexible protective layer 2. Therefore, the original audio emitted from the speaker of the electronic device is processed via an audio enhancing and amplifying system 3.

According to certain embodiments of the present invention, multiple amplifying openings 32 include bottom amplifying openings 321 and side amplifying openings 322. The multiple amplifying openings 32 is constructed along the center line M-M of the audio enhancing and amplifying system 3 in a symmetrical fashion. At the rear portion of the audio enhancing and amplifying system 3, there are two ridges 34. The ridges 34 are also built in a symmetrical fashion to the center line M-M of the audio enhancing and amplifying system 3. And the bottom amplifying openings 321 are built in form of dot matrix and consists two or more columns and multiple rows. The symmetrical arrangement of the system is chosen so that the audio is uniformly emitted through the protective case.

The audio amplifying chamber 31 is built on the outer wall 12 of the outer hard layer of the protective case 1 and corresponds to the protrusion 13. The ridge 34 on the outer wall 12 consists of 2 or more symmetrical recess grooves 14. According to a certain embodiment of the present invention, the multiple amplifying openings 32 are construction in a fashion to be able to emit the sound in multiple directions.

The audio amplifying chamber 31 is built in a fashion that the difference between the thickness of the audio enhancing and amplifying system 3 and the thickness of the rear portion of the outer layer 1 is relatively small, so that the strength of the protective case will not decrease in any way.

According to certain embodiments of the present invention, the installation of the rear portion of the outer hard layer 1 and the inner soft layer 2 are simple and easy.

According to certain embodiments of the present invention, the edge of the inner flexible protective layer 2 and the edge of the rear portion of the outer protective layer 1 are formed together to be able to accommodate the front portion of the outer protective layer 4. And the inner flexible layer 4 is encased by the front portion of the outer protective layer 4 and the rear portion of the outer protective layer 1.

Based on the above preferred embodiment of the present invention, the enclosed structure of the audio enhancement and amplifying system 3 is constructed in a fashion that the acoustic sound waves is enclosed in an enclosed structure, so that the amplification and enhancement of the sound is able to take place.

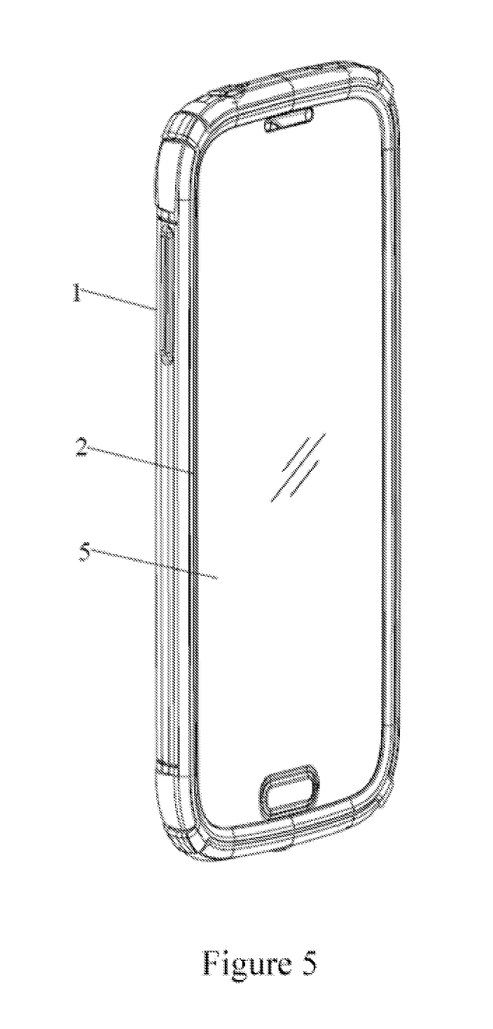

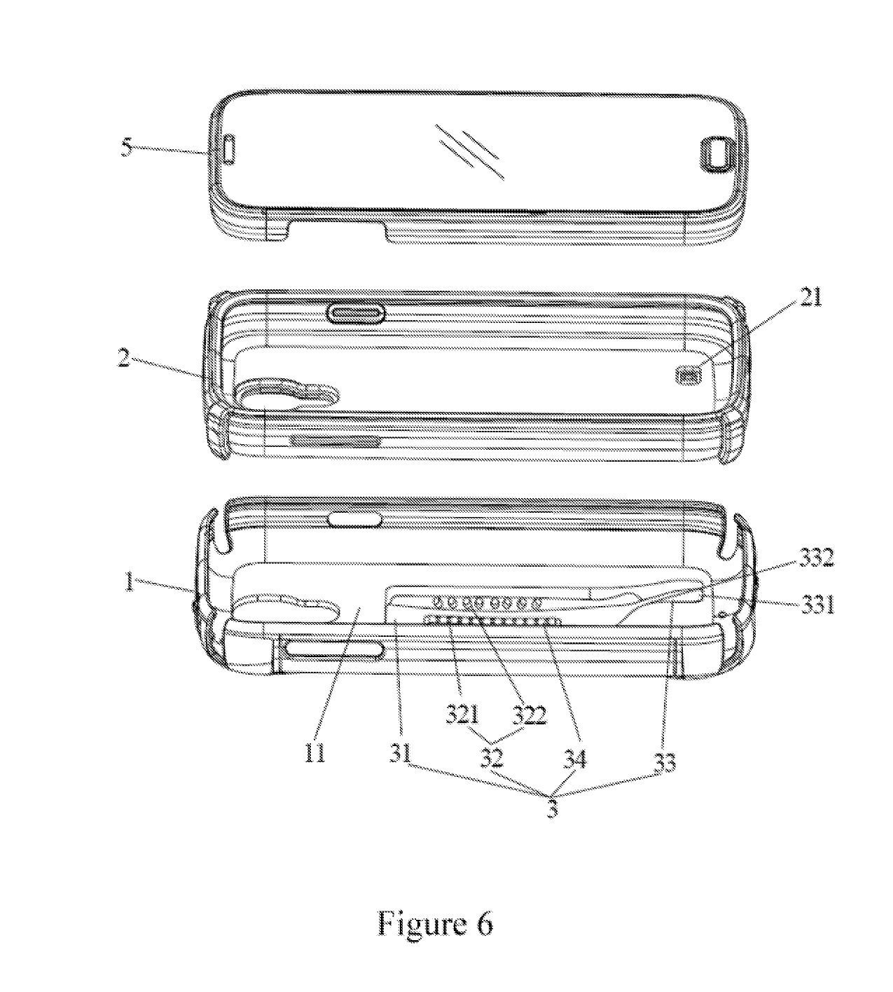

As shown in FIGS. 5 and 6, according to another embodiment of the present invention, the front portion of the outer layer 5 consists of the transparent lens to protection the display screen of the electronic device. The edge of the front portion of the outer layer 5 with transparent lens and the edge of the rear portion of the outer layer 1 are latching in a way to enclose the inner flexible protective layer 2.

Although the detailed description of the invention has been presented in considerable detail with reference to certain preferred versions thereof, it is for illustrated and descriptive purposes only. It is not intended to limit the invention to the precise form disclosed. Other variations or forms may be possible in light of the above descriptive explanation of the invention. The embodiment was chosen and described in order to best explain the main principles of the invention and its practical application. Therefore, the spirit and scope of the appended claims should be construed to include other alternative embodiments of the invention and should not necessarily be limited to the description of the preferred version contained therein.

What is claimed is:

1. An electronic device protective case, comprising a front cover and a rear cover of outer layer, and an inner flexible layer. The rear cover of outer layer further comprises an inner wall and an outer wall. And the inner flexible layer is enclosed by the inner wall of the outer layer and the front cover of the outer layer. And the rear cover of the outer layer further comprises an audio enhancing and amplifying system.

2. The case of claim 1, wherein the audio enhancing and amplifying system comprises an amplifying chamber on the inner wall. The amplifying chamber further comprises multiple amplifying openings and audio guide channel. The starting point of the audio guide channel is located at the speaker of the electronic device and the end point of the audio guide channel is located at the amplifying chamber. And the inner flexible layer comprises at least one opening for audio, which corresponds to the speaker of the electronic device; and the opening for audio corresponds to the starting point of the audio guide channel.

3. The case of claim 2, wherein the multiple amplifying openings are built in a fashion that the sound broadcasted though the multiple amplifying openings is emitted in different directions.

4. The case of claim 2, wherein the multiple amplifying openings comprise rear amplifying openings and side amplifying openings. The multiple amplifying openings are vertically symmetrical to the center line of the amplifying chamber.

5. The case of claim 4, wherein the amplifying chamber comprises at least 2 back ridges. The back ridges are vertically symmetrical to the center line of the amplifying chamber. And the back ridges further comprise multiple rear amplifying openings along the vertical lines.

6. The case of claim 5, wherein the amplifying chamber is built at the position where a protrusion is formed on the outer wall of the back cover.

7. The case of claim 6, wherein the position of the edge of the back cover of the outer layer is at the edge of the inner flexible layer and corresponds to the front frame. The Inner flexible layer is encased between the front frame and the back cover of the protective case's outer layer.

8. The case of claim 6, wherein the front frame comprises transparent lens. The front frame with the transparent lens further comprises an edge corresponds to the edge of the back cover of the protective case. And the inner flexible layer is encased between the front frame with lens and the back cover of the protective case's outer layer.

9. The case of claim 6, wherein the inner flexible layer and the back cover of the outer layer snap onto each other easily.
